(19) United States
(12) Patent Application Publication
(10) Pub. No.: US 2021/0158280 A1
(43) Pub. Date: May 27, 2021

(54) INFORMATION PROCESSING APPARATUS, INFORMATION PROCESSING METHOD AND PROGRAM MEDIUM

(71) Applicant: Toyota Jidosha Kabushiki Kaisha, Toyota-shi Aichi-ken (JP)

(72) Inventors: Shintaro Matsutani, Kariya-shi (JP); Aya Sato, Miyoshi-shi (JP); Yasuki Nakagawa, Toyota-shi (JP); Shigeru Inamori, Nagoya-shi (JP); Fuminori Matsuoka, Toyota-shi (JP); Taro Hasegawa, Toyota-shi (JP); Masaki Nanahara, Toyota-shi (JP); Misaki Sato, Nisshin-shi (JP); Motoki Maekawa, Nagakute-shi (JP); Hiroki Ashizawa, Toyota-shi (JP)

(21) Appl. No.: 17/102,728

(22) Filed: Nov. 24, 2020

(30) Foreign Application Priority Data
Nov. 26, 2019 (JP) 2019-213380

(51) Int. Cl. G06Q 10/08; G06Q 10/06

(52) U.S. Cl. CPC G06Q 10/0832; G06Q 10/0836; G06Q 10/0835; G06Q 10/06314

(57) ABSTRACT

An information processing apparatus includes a controller that acquires delivery information including information concerning one or more packages transported by a vehicle or a recipient of the one or more packages, and selects, based on the delivery information, one or more service units to be loaded on the vehicle from among a plurality of service units having different capabilities that provides a service associated with the one or more packages.

### CROSS REFERENCE TO RELATED APPLICATION

This application claims priority to Japanese Patent Application No. 2019-213380, filed on Nov. 26, 2019, incorporated herein by reference in its entirety.

### BACKGROUND

### Technical Field

The present disclosure relates to a technique of providing a delivery service by vehicle.

Attempts have been made to provide services by sending autonomous cars designed for various purposes. For example, Patent document 1 discloses an apparatus that determines a vehicle to be sent based on the demand for a service and the availability of vehicles and indicates the vehicle to move.

The vehicle is formed by a combination of a vehicle platform (chassis) and a cabin module (cabin), and the cabin can be changed to meet various demands. For example, if a module configured to transport a package is installed, delivery by an autonomous driving vehicle can be done.

### CITATION LIST

Patent Document 1: Japanese Patent Laid-Open No. 2019-075047

### SUMMARY

In the unattended delivery of a package by vehicle, a device configured to provide an additional service may be accompanied to the package.

The present disclosure has been devised in view of the problem described above, and an object of the present disclosure is to provide an appropriate service to a recipient of a package.

A first aspect of the present disclosure is an information processing apparatus that generates a command to load a service unit, which is accompanied to a package transported by a vehicle and provides a service, on the vehicle.

More specifically, the information processing apparatus includes a controller configured to acquire delivery information including information concerning one or more packages transported by a vehicle or a recipient of the one or more packages, and select, based on the delivery information, one or more service units to be loaded on the vehicle from among a plurality of service units having different capabilities that is accompanied to the one or more packages and provides a service.

A second aspect of the present disclosure is an information processing method performed by the information processing apparatus described above.

More specifically, the information processing method includes a step of acquiring delivery information including information concerning one or more packages transported by a vehicle or a recipient of the one or more packages; and a step of selecting, based on the delivery information, one or more service units to be loaded on the vehicle from among a plurality of service units having different capabilities that is accompanied to the one or more packages and provides a service.

Another aspect is a program that makes a computer perform the information processing method performed by the information processing apparatus described above, or a computer readable memory medium that non-temporarily stores the program.

According to the present disclosure, an appropriate service can be provided to a recipient of a package.

### BRIEF DESCRIPTION OF THE DRAWINGS

FIG. 1 is a diagram illustrating a general configuration of a delivery system according to a first embodiment.

FIG. 2A illustrates examples of a service unit that conveys a package.

FIG. 2B illustrates examples of a service unit that stores a package.

FIG. 3A is a diagram illustrating a combination of service units loaded on a vehicle.

FIG. 3B is a diagram illustrating a second combination of service units loaded on a vehicle.

FIG. 3C is a diagram illustrating a third combination of service units loaded on a vehicle.

FIG. 3D is a diagram illustrating a fourth combination of service units loaded on a vehicle.

FIG. 3E is a diagram illustrating a fifth combination of service units loaded on a vehicle.

FIG. 3F is a diagram illustrating a sixth combination of service units loaded on a vehicle.

FIG. 4 is a diagram illustrating a system configuration of a server apparatus.

FIG. 5A illustrates an example of vehicle data.

FIG. 5B illustrates an example of service data.

FIG. 6 is a diagram illustrating a system configuration of the service unit and the vehicle.

FIG. 7 is a flowchart illustrating a process performed by the server apparatus.

FIG. 8 illustrates an example of delivery data obtained by the server apparatus.

FIG. 9 is a flowchart illustrating processings performed by the server apparatus in Step S13.

FIG. 10 is a flowchart illustrating a process performed by the vehicle.

### DESCRIPTION OF THE EMBODIMENTS

An information processing apparatus according to an embodiment is an apparatus that determines a service unit to be accompanied to a package in a system that transports a package by vehicle.

The service unit is a unit that provides a service until the package is picked up by the recipient. For example, the service unit is a unit that conveys a package from the vehicle to the entrance, a unit that stores a package at the destination, or a unit that refrigerates a package during transportation. The service unit is loaded on the vehicle along with the package and used during transportation or at the destination.

The vehicle in the embodiment is a mobile body provided with a plurality of wheels and a power source. The vehicle has only to be able to run and does not have to have a cabin. The vehicle is configured so that a plurality of service units can be loaded thereon.

By loading a service unit on the vehicle, a service that would otherwise be unable to be provided by the unattended vehicle can be provided. For example, if a small unit configured to autonomously move with a package loaded thereon is used, a package can be carried to the entrance. If a service unit configured to temporarily store a package is used, a parcel locker can be placed at a location specified by the recipient.

The information processing apparatus according to the embodiment is such an apparatus that selects a service unit to be accompanied to a package.

In the information processing apparatus according to the embodiment, a controller acquires delivery information including information concerning one or more packages transported by a vehicle or a recipient of the one or more packages, and selects, based on the delivery information, one or more service units to be loaded on the vehicle from among a plurality of service units having different capabilities.

The delivery information is information concerning the package to be transported or the recipient of the package and typically is information concerning the size, weight or temperature range (such as room temperature, refrigeration or freezing) of the package, information concerning the time zone in which the recipient is at home, information concerning the location of the recipient (such as information that identifies the building), for example. However, the delivery information may include other information. Based on the delivery information, what kind of service unit should be loaded on the vehicle when delivering a package to the recipient can be determined.

For example, if the package to be delivered is a package that needs to be refrigerated, the temperature of the package can be managed during transportation by loading a service unit having a refrigeration capability on the vehicle.

The controller may further generate a command to load the selected one or more service units on the vehicle.

The plurality of service units may include a first apparatus that conveys a package from the vehicle to the recipient or a second apparatus that functions as a parcel locker capable of being locked with a package contained therein.

The first apparatus is a unit that conveys a package from the vehicle to the recipient (such as the entrance of the building). The unit may be a small mobile body capable of autonomous traveling.

The second apparatus is a unit having a function of a parcel locker. By placing the second apparatus with a package contained therein at the location of the recipient (such as the entrance of a collective house), unattended delivery can be achieved.

The delivery information may include information concerning a location of the recipient, and the controller may select at least the first apparatus that is suitable for the location of the recipient based on the delivery information.

Selecting the first apparatus suitable for the location includes selecting the first apparatus having a capability of conveying a package to the recipient at the location, for example.

For example, by selecting a unit having an appropriate traveling capability based on the information concerning the location of the recipient (such as the presence or absence of a flight of stairs, a slope or an elevator), the package can be appropriately delivered.

The delivery information may include information concerning a location of the recipient, and the controller may select at least the second apparatus that is suitable for the location of the recipient based on the delivery information.

Selecting the second apparatus suitable for the location includes selecting the second apparatus that can be accepted by the house that is the residence of the recipient, for example.

For example, if the residence of the recipient is a detached house, a unit having a single compartment can be selected, and if the residence of the recipient is a collective house, a unit having a plurality of compartments can be selected.

The delivery information may include information that allows estimation of a time zone in which the recipient is at home, and the controller may estimate whether the recipient is at home at the time of delivery based on the delivery information and select at least the second apparatus when it is estimated that the recipient is away from home.

When it is estimated that the recipient is away from home, if a service unit having a function of a parcel locker is loaded on the vehicle, redelivery can be avoided.

The second apparatus may be any of a room-temperature storage unit and a refrigerator storage unit having a refrigeration capability.

The unit selected can be determined based on the delivery information.

At least when it is estimated that the recipient is away from home, the controller may select a unit suitable for a package from the room-temperature storage unit and the refrigerator storage unit based on the delivery information. Furthermore, the controller may further determine whether a power supply unit that supplies electricity to the refrigerator storage unit is required or not based on the delivery information.

For example, if the package to be delivered is a package that needs to be refrigerated and it is estimated that the recipient is away from home, the second apparatus having a refrigeration capability may be selected. Furthermore, based on the time from the arrival to the pickup, a power supply unit of an appropriate capacity can also be added.

The controller may select a service unit for each package transported by the vehicle.

The service unit may be determined for each package, and based on the result of the determination, the number and types of the service units to be finally loaded on the vehicle may be determined.

In the following, embodiments of the present disclosure will be described. The configurations of the embodiments described below are given for illustrative purposes, and the present disclosure is not limited to the configurations of the embodiments.

### First Embodiment

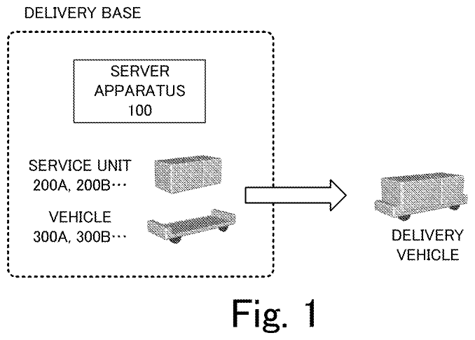

An overview of a delivery system according to a first embodiment will be described with reference to FIG. 1. The delivery system according to this embodiment includes one or more vehicles 300A, 300B and so on that autonomously travel according to a received command, one or more service units 200A, 200B and so on loaded on the vehicles, and a server apparatus 100 that issues the command.

In the following, a plurality of vehicles that does not need to be distinguished from one another will be generically referred to simply as a vehicle 300. A plurality of service units that does not need to be distinguished from one another will be generically referred to simply as a service unit 200.

The vehicle 300 is an automatic vehicle capable of travelling with the service unit 200 loaded thereon. The vehicle 300 does not need to be an unattended vehicle. For example, a safety attendant can be on the vehicle. The vehicle 300 may not be a vehicle of totally autonomous operation. For example, the vehicle may be operated or assisted by a person depending on the situation.

The service unit 200 is a unit that provides a predetermined service involved with the transport of a package. The delivery system according to this embodiment uses a plurality of service units 200 having different functions to transport a package. The service units include (1) an autonomously moving robot (first apparatus) that conveys a package from the vehicle to the location of a recipient (entrance of the house), (2) a parcel locker-type apparatus (second apparatus) that is placed with the package contained therein, and (3) a unit (third apparatus) that serves as a luggage compartment of the vehicle 300, for example. Of these apparatuses, the first and second apparatuses are units that are used after the vehicle arrives at a predetermined destination address and before the package is passed to the recipient.

In the following, the service unit 200 that can autonomously move and convey a package will be referred to also as a conveyor apparatus 200. The service unit 200 that has a function of a parcel locker will be referred to also as a parcel locker 200.

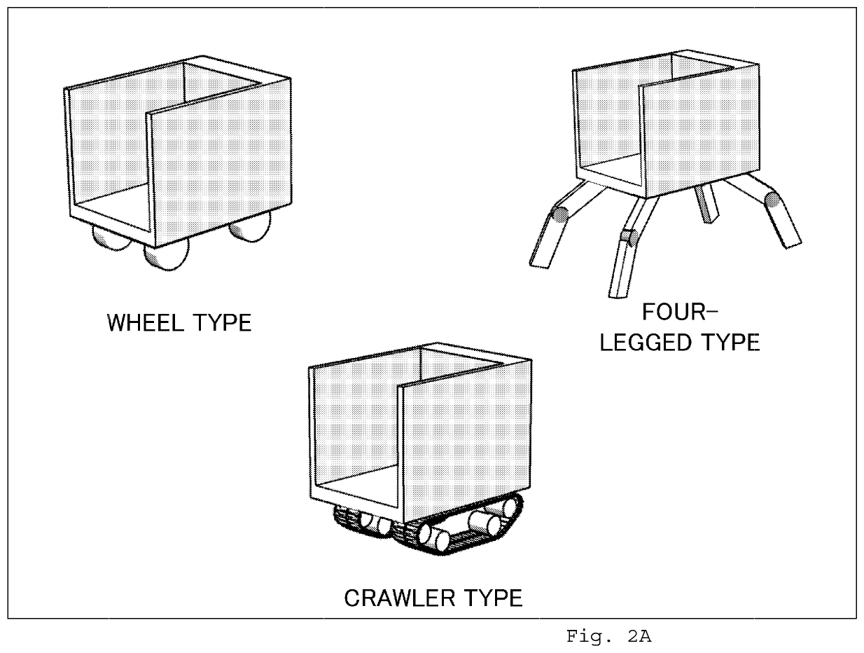

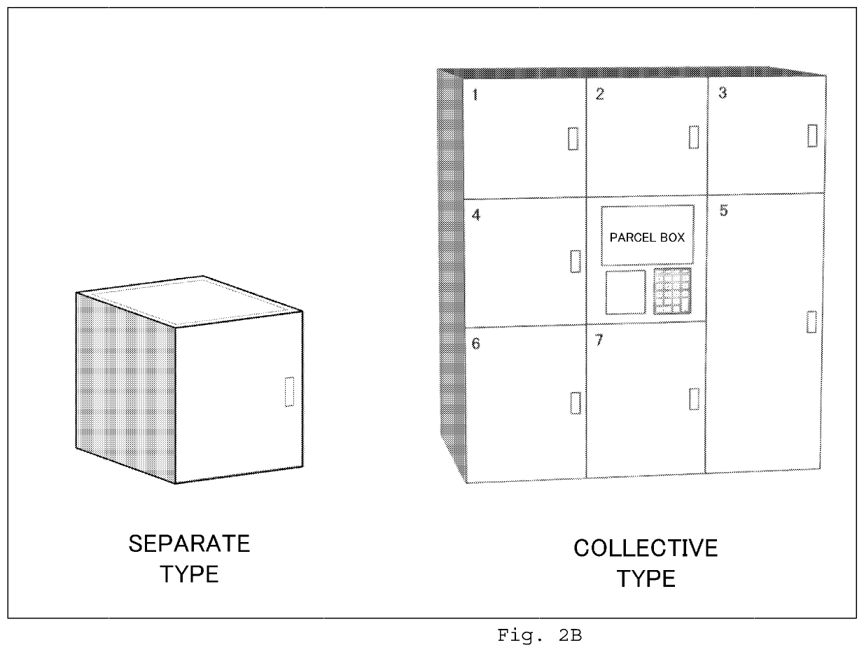

FIG. 2A is a diagram illustrating appearances of service units 200 (conveyor apparatuses 200) that can convey a package. As illustrated, the conveyor apparatus 200 has a frame on which a package is loaded and a mechanism that enables the apparatus to move, and is configured to be able to move with the package held thereon. Any moving mechanism can be used, such as wheels, crawlers or legs. The first apparatus can convey the package from the vehicle to the location of the recipient (such as the entrance of a specified building).

FIG. 2B is a diagram illustrating appearances of service units 200 (parcel lockers 200) serving as a parcel locker. As illustrated, the parcel locker 200 has one or more compartments that can be locked and is configured to be able to be accessed by the recipient. The parcel locker 200 is placed at the location of the recipient. The recipient can unlock the parcel locker 200 via an interface provided on a housing of the parcel locker 200. The parcel locker 200 may be of a type capable of containing a single package (separate type) or of a type capable of containing a plurality of packages (collective type). If the recipient lives in a detached house, the separate type can be used, and if the recipient lives in an apartment house, the collective type can be used, for example.

In this embodiment, at a delivery base (such as a branch office of a delivery company), a plurality of packages is loaded onto the vehicle, and a service unit 200 required to deliver the packages is loaded on the vehicle. If a package needs to be conveyed from the vehicle to the entrance of the building, for example, the conveyor apparatus 200 illustrated in FIG. 2A is also loaded on the vehicle. If the recipient is expected to be away from home, for example, the parcel locker 200 illustrated in FIG. 2B is also loaded on the vehicle. With such a configuration, a delivery service appropriate for an attribute or status of the package or recipient can be provided.

The server apparatus 100 is an apparatus that manages the operation of the vehicle 300.

As illustrated, there is a plurality of service units 200 having different capabilities, so that an appropriate service unit needs to be selected and loaded on the vehicle.

To this end, the server apparatus 100 determines the number and types of the server apparatuses to be loaded, according to the attribute of the package to be transported (or the recipient of the package). With the delivery system according to this embodiment, a predetermined service unit 200 is loaded on the vehicle 300 according to the determination by the server apparatus 100.

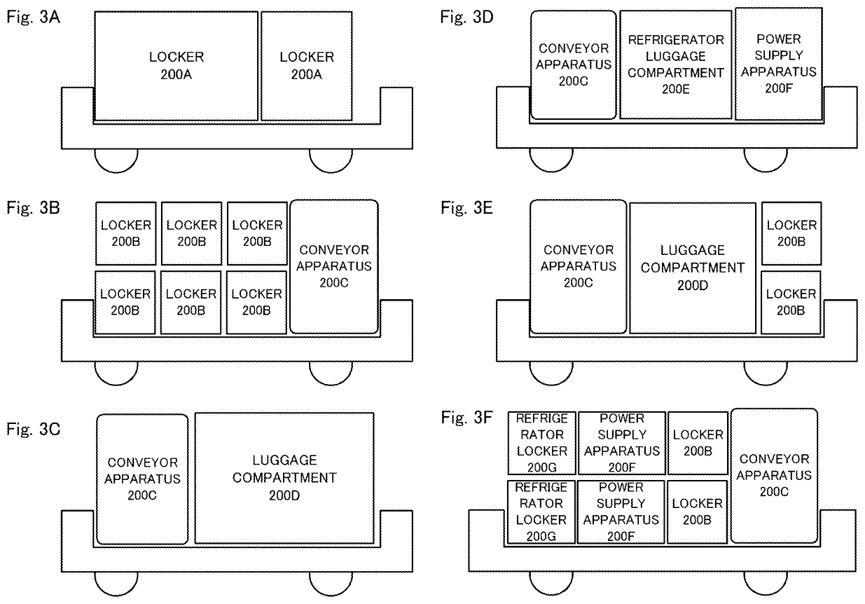

FIG. 3 is a diagram for illustrating types of service units 200 loaded on the vehicle 300.

FIG. 3A illustrates an example in which two collective-type parcel lockers 200A are loaded on the vehicle 300. If all the packages are destined to an apartment house, the server apparatus 100 can make such a selection. The parcel locker 200A may be able to be autonomously unloaded from the vehicle by an accessory elevator.

FIG. 3B illustrates an example in which six separate-type parcel lockers 200B are loaded on the vehicle 300. If all the packages are destined to a detached house, the server apparatus 100 can make such a selection. In this example, a conveyor apparatus 200C that conveys the parcel lockers 200B to the entrance of the house is also loaded on the same vehicle.

If no parcel locker is needed, for example, as illustrated in FIG. 3C, only a service unit serving as a luggage compartment in which the packages are loaded (luggage compartment 200D) and the conveyor apparatus 200C that conveys the packages may be loaded on the vehicle 300.

FIG. 3D illustrates an example in which a package whose temperature needs to be controlled (such as a package that needs to be refrigerated) is transported. In this example, instead of the luggage compartment 200D, a refrigerator-type luggage compartment 200E incorporating a cooling apparatus and a power supply apparatus 200F that supplies electricity to the luggage compartment 200E are loaded on the vehicle 300. With such a configuration, the package can be refrigerated during transportation.

If a package that requires a parcel locker and a package that does not require a parcel locker are mixed, as illustrated in FIG. 3E, both the luggage compartment and the parcel locker can be loaded on the vehicle.

FIG. 3F illustrates an example in which a parcel locker 200G having a refrigeration capability is loaded on the vehicle. The parcel locker 200G incorporates a cooling apparatus and functions as a refrigerator parcel locker on the electricity supplied from a power supply apparatus 200F. With such a configuration, a package that needs to be refrigerated can be delivered with a parcel locker.

As described above, the server apparatus 100 can determine the number and types of the service units loaded on the vehicle 300 depending on the package(s) to be transported.

Furthermore, the server apparatus 100 issues a command that indicates an operation (referred to as an operation command hereinafter) to the vehicle 300. The operation command is not limited to those that instructing the travel. For example, the operation command may be “to unload a predetermined parcel locker at the destination address”, “to convey a package (parcel locker) to a destination building on the conveyor apparatus after arrival at the destination address” or “to notify the recipient of the arrival after arrival at the destination address”. That is, the operation command may be related to not only the traveling but also a task performed by the vehicle 300 or the service unit 200.

The server apparatus 100, the service unit 200 and the vehicle 300 are interconnected over a network. The network may be a wide area network (WAN) that is a global public communication network, such as the Internet, or other communication networks. The network may include a telephone network for cellular phones or the like or a wireless communication network, such as Wi-Fi (registered trademark).

Next, the server apparatus 100 will be described in detail.

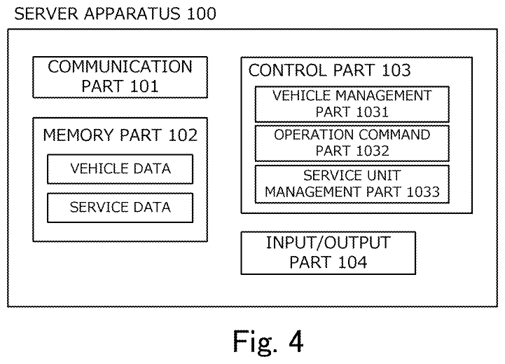

FIG. 4 is a diagram illustrating a system configuration of the server apparatus 100. The server apparatus 100 includes a communication part 101, a memory part 102, a control part 103 and an input/output part 104.

The server apparatus 100 is constituted by a common computer. Specifically, the server apparatus 100 is a computer having a processor, such as a CPU or GPU, a main memory, such as a RAM or a ROM, and an auxiliary memory, such as an EPROM, a hard disk drive or a removable medium. The removable medium may be an USB memory or a disk recording medium, such as a CD or a DVD. The auxiliary memory stores an operating system (OS), various programs, or various tables, and each of the various functions described later suitable for a predetermined purpose can be implemented by loading a program stored in the auxiliary memory into a working area of the main memory and executing the program to control each component or the like. However, some or all of the functions may be implemented by a hardware circuit, such as ASIC or FPGA. The server apparatus 100 may be constituted by a single computer or a plurality of computers associated with each other.

The communication part 101 is a communication interface that connects the server apparatus 100 to the network. The communication part 101 includes a network interface board and a wireless communication circuit for wireless communication.

The memory part 102 includes the main memory and the auxiliary memory. The main memory is a memory in which a program to be executed by the control part 103 or data to be used by the control program is deployed. The auxiliary memory is a memory that stores a program to be executed by the control part 103 or data to be used by the control program.

The memory part 102 further stores vehicle data and service data.

The vehicle data is data for managing the vehicle 300.

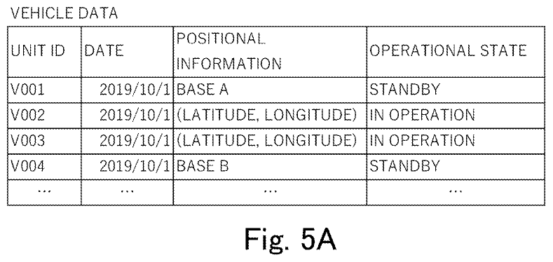

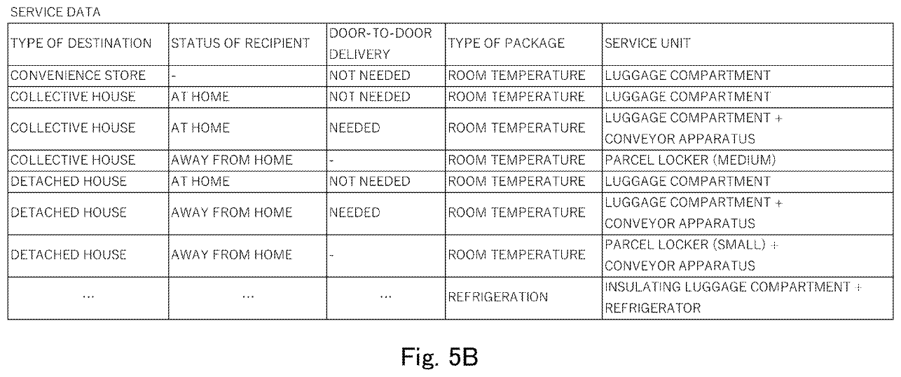

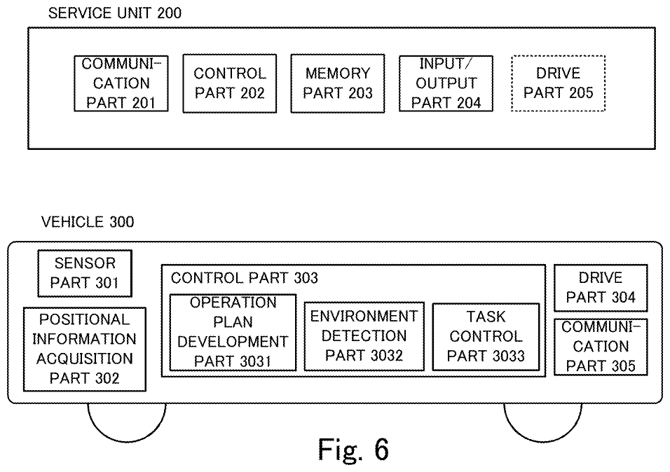

FIG. 5A illustrates an example of the vehicle data. The vehicle data is data that describes the identifier of the vehicle 300 managed by the server apparatus, positional information on the vehicle 300 or the operational state of the vehicle 300, for example. Note that the vehicle data may include other information. For example, the vehicle data may include information on the use, type or standby point (shed or branch office) of the vehicle 300, or information on the vehicle size, the load capacity, the distance to empty at the time when the vehicle is fully charged, the current distance to empty, the current load quantity, weight and volume, the destination address or the identifier of the service unit 200 currently loaded.

The vehicle data is periodically updated based on information transmitted from the vehicle 300.

The service data is data for determining the service unit 200 to be used for delivery of a package.

FIG. 5B illustrates an example of the service data. In the example illustrated in the drawing, the service unit to be loaded on the vehicle 300 is defined on a basis of the type of the destination building, the type of the package and the status of the recipient.

For example, if the destination building is a convenience store, only the luggage compartment is loaded on the vehicle 300.

If the destination building is an apartment house and the recipient is at home, and if the door-to-door delivery will not be performed (that is, the recipient will come to the vehicle to receive the package), only the luggage compartment is loaded on the vehicle 300. If the door-to-door delivery will be performed, the conveyor apparatus is loaded on the vehicle 300 in addition to the luggage compartment.

If the destination building is an apartment house, and the recipient is away from home, a parcel locker with the package contained therein is loaded on the vehicle 300.

By referring to such service data, the server apparatus 100 can determine the number and types of the service units 200 to be accompanied to the package.

A database that stores these pieces of data is constructed by a program of a database management system (DBMS) executed by the processor managing the data stored in the memories. The database used in this embodiment is a relational database, for example.

The control part 103 is a computing device that is responsible for the control performed by the server apparatus 100. The control part 103 can be implemented by an arithmetic processing unit, such as a CPU.

The control part 103 has three functional modules, specifically, a vehicle management part 1031, an operation command part 1032 and a service unit management part 1033. Each of the functional modules may also be implemented by the CPU executing a program stored in the auxiliary memory.

The vehicle management part 1031 collects information concerning the vehicle 300 and updates the vehicle data. Specifically, the vehicle management part 1031 periodically communicates with a plurality of vehicles 300 to collect information concerning the vehicles 300. The collected information is reflected in the vehicle data.

The operation command part 1032 generates a command (operation command) to operate the vehicle 300.

The operation command is a command concerning a task of making the vehicle 300 travel and a task performed by the service unit 200 at the destination. For example, the operation command includes information concerning the destinations of a plurality of packages (such as the location of the recipient, the building, the room, the point at which the package is passed to the recipient, or the point at which the vehicle is parked), the way of delivery (such as whether to hand over the package or to use the parcel locker), or the way of conveyance of the package from the vehicle to the point at which the package is passed to the recipient (such as whether to use the conveyor apparatus or to call the recipient).

The vehicle 300 operates according to the operation command generated by the operation command part 1032.

The service unit management part 1033 determines the service unit 200 to be loaded on the vehicle 300. As described above, the service unit 200 to be loaded on the vehicle 300 varies depending on the attribute of the package or the status of the recipient (such as whether the recipient is at home or away from home or whether the door-to-door delivery is needed or not), so that the service unit management part 1033 selects an appropriate service unit based on the service data.

A specific example of the selection of the service unit is as follows.

For example, the service unit management part 1033 selects an appropriate conveyor apparatus from the conveyor apparatuses 200 having different mechanisms based on the location of the recipient or whether the door-to-door delivery is needed or not.

The service unit management part 1033 also determines whether to add a parcel locker 200 to the package or use only the luggage compartment 200D to deliver the package based on the information indicating whether the recipient is at home or away from home.

The service unit management part 1033 further determines whether to use a luggage compartment or parcel locker of the normal type or a luggage compartment or parcel locker of the refrigerator type based on the temperature management (refrigeration) is needed or not. In this step, the service unit management part 1033 may further determine to add an apparatus that supplies electricity to the refrigerator-type parcel locker based on the length of time of the refrigeration of the package.

The input/output part 104 is an interface that presents information to a user of the system (typically, a staff member of the delivery company, which will be referred to simply as a staff member), and obtains information. The input/output part 104 is constituted by a display device or a touch panel, for example. The input/output part 104 may have a unit that transmits data to and receives data from another apparatus.

Next, the service unit 200 will be described.

In this embodiment, the service unit 200 is any one of a plurality of units having different functions. In the following, components common to the plurality of units will be described.

The service unit 200 includes a communication part 201, a control part 202, a memory part 203 and an input/output part 204 and optionally a drive part 205. The service unit 200 operates on the electricity supplied from a battery.

The communication part 201 is a communication interface that communicates with the vehicle 300.

The control part 202 is a computer that controls the operation of the service unit. The control part 202 is constituted by a microcomputer, for example. The control part 202 may be implemented by a central processing unit (CPU) executing a program stored in a memory unit, such as a read only memory (ROM).

The memory part 203 is a unit that stores information and is constituted by a memory medium, such as a RAM, a magnetic disk or a flash memory. If the service unit 200 is a parcel locker, the memory part 203 can store authentication information required for checking when the package is passed to the recipient.

The input/output part 204 is an interface on which information is input by or output to the recipient. The input/output part 204 is constituted by a display device or a touch panel, for example. If the service unit 200 is a parcel locker, information (such as authentication information) required for the recipient to receive the package may be exchanged on the input/output part 204. If the service unit 200 is a conveyor apparatus, the recipient's signature can be obtained via the input/output part 204. The input/output part 204 may include a keypad used to enter a PIN, a camera that reads a two-dimensional barcode, a short-range communication unit for wireless transmission, or a touch screen, for example.

If the service unit 200 is a conveyor apparatus, the service unit 200 may further have a unit (drive part 205) for autonomous movement. The drive part 205 may include a unit for moving on a road, a unit for holding a package or a unit for lifting a package, for example.

If the service unit 200 is a parcel locker, the service unit 200 may include a unit for connecting to a structure. For example, if the service unit 200 is connected to an anchor, a rail or the like fixed to the road surface or a building, the service unit can be prevented from being stolen. Furthermore, the parcel locker may be provided with the drive part 205 so that the parcel locker can autonomously move from the vehicle to the point of placement.

The vehicle 300 is a vehicle platform that travels according to an operation command obtained from the server apparatus 100. More specifically, the vehicle 300 generates a travel route based on an operation command obtained by wireless communication and travels on the road in an appropriate manner while sensing the surroundings of the vehicle. Furthermore, after the vehicle 300 arrives at the destination address, the vehicle 300 make the service unit 200 perform a predetermined task. In this way, a parcel locker can be placed, or the package can be conveyed to the entrance.

The vehicle 300 includes a sensor part 301, a positional information acquisition part 302, a control part 303, a drive part 304 and a communication part 305. The vehicle 300 operates on the electricity supplied from a battery.

The sensor part 301 is a unit that senses the surroundings of the vehicle and typically includes a stereo camera, a laser scanner, a LIDAR or a radar, for example. Information obtained by the sensor part 301 is transmitted to the control part 303. The sensor part 301 includes a sensor for enabling autonomous traveling.

The sensor part 301 may include a camera provided on the vehicle 300. For example, the sensor part 301 may include a picture-taking device using an image sensor, such as a Charge Coupled Device (CCD) image sensor, a metal-oxide-semiconductor (MOS) image sensor or a complementary metal-oxide-semiconductor (CMOS) image sensor.

The positional information acquisition part 302 is a unit that acquires the current location of the vehicle 300 and typically includes a GPS receiver. Information acquired by the positional information acquisition part 302 is transmitted to the control part 303.

The control part 303 is a computer that controls the vehicle 300 based on the information obtained from the sensor part 301. The control part 303 is constituted by a microcomputer, for example.

The control part 303 has an operation plan development part 3031, an environment detection part 3032 and a task control part 3033 as functional modules. Each of the functional modules may be implemented by a central processing unit (CPU) executing a program stored in a memory unit, such as a read only memory (ROM).

The operation plan development part 3031 obtains an operation command from the server apparatus 100 and develops an operation plan. In this embodiment, the operation plan is data that prescribes a travel route and a procedure to be performed at the destination.

The travel route can be automatically generated based on a given point of departure and a given point of destination by referring to map data stored in advance. Alternatively, the travel route may be generated using an external service.

The procedure to be performed at the destination may be “to convey the package with the conveyor apparatus”, “to notify the recipient of the arrival of the package”, “to place the parcel locker” or “to remove the parcel locker”, for example. However, the procedure is not limited to these procedures but can be any procedure in which the service unit 200 performs a predetermined task.

The operation plan developed by the operation plan development part 3031 is transmitted to the task control part 3033 described later.

The environment detection part 3032 detects the environment surrounding the vehicle based on the data from the sensor part 301. What is detected may be the number and positions of the lanes, the number and positions of the vehicles around the vehicle, the number and positions of the obstacles (such as pedestrians, bicycles, structures or buildings) around the vehicle, the configuration of the road or traffic signs, without limitation. Anything required to enable the autonomous traveling can be detected. The environment detection part 3032 can also track a detected object.

The data concerning the environment (referred to as environmental data hereinafter) generated by the environment detection part 3032 is transmitted to the task control part 3033 described below.

The task control part 3033 controls the traveling of the vehicle based on the operation plan developed by the operation plan development part 3031, the environmental data generated by the environment detection part 3032 and the positional information on the vehicle obtained by the positional information acquisition part 302. For example, the task control part 3033 makes the vehicle travel along a predetermined route in such a manner that any obstacle does not enter a predetermined safety zone centered at the vehicle. The method of making the vehicle autonomously travel can be a well-known method.

The task control part 3033 can also make the service unit 200 perform a predetermined task based on the operation plan developed by the operation plan development part 3031 (and the environmental data generated by the environment detection part 3032, the positional information on the vehicle obtained by the positional information acquisition part 302 or the like, as required).

The drive part 304 is a unit that makes the vehicle 300 travel based on a command generated by the task control part 3033. The drive part 304 includes a motor for driving a wheel, an inverter, a brake, a steering mechanism and a secondary battery, for example.

The communication part 305 is a communication unit that connects the vehicle 300 to the network. In this embodiment, the communication part 305 can communicate with the server apparatus 100 and the service unit 200 over a network using a mobile communication service, such as 3G, LTE or 5G.

The communication part 305 may further has a communication unit for inter-vehicle communication with another vehicle.

The service unit 200 can be loaded in the cabin or on the bed of vehicle 300. The vehicle 300 can also be configured so that a plurality of service units 200 can be loaded. The vehicle 300 can also be provided with a mechanism (including an elevator, an actuator and a guide rail) that lifts and lowers only a predetermined service unit 200 of a plurality of service units 200.

These components are controlled by the task control part 3033.

The vehicle 300 periodically notifies the server apparatus 100 of the status of the vehicle (such as the positional information, which will be referred to as vehicle information hereinafter). The server apparatus 100 (vehicle management part 1031) updates the vehicle data based on the notified information. The vehicle 300 may transmit other information, such as the information illustrated below, as the vehicle information to the server apparatus 100.

The size, weight, number or the like of the service units that can be loaded.

The identifier, volume, weight or the like of the service unit(s) currently loaded.

The current state of charge (SOC).

The distance to empty.

Information concerning the operation route (in the case where the vehicle is in operation).

Information concerning a task performed by a service unit.

Next, a method of transporting a package using a service unit will be described.

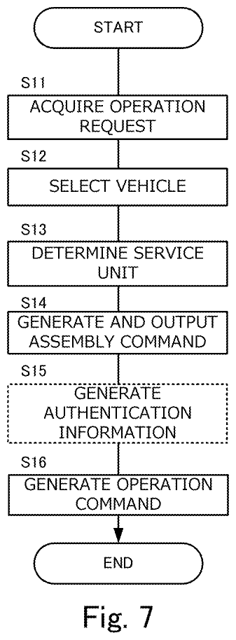

FIG. 7 is a flowchart illustrating a process of the server apparatus 100 generating an operation command based on an operation request from a staff member of a delivery company.

When a staff member of a delivery company inputs an operation request to the server apparatus 100 (Step S11), the server apparatus 100 starts generating an operation command in response to the request.

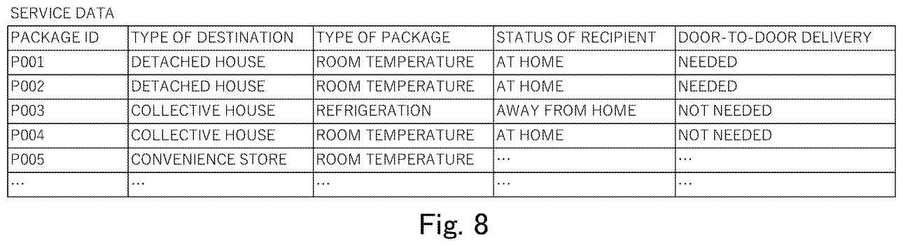

The operation request includes data concerning a package to be transported and a recipient of the package (referred to as delivery data hereinafter). FIG. 8 illustrates an example of the delivery data. The delivery data includes an ID that uniquely identifies the package, the type of the destination building, the type of the package, the status of the recipient, and information concerning whether the door-to-door delivery is needed or not, for example.

The type of the destination building is information that identifies whether the destination building is a detached house, a collective house or other facilities, for example.

The type of the package is information that specifies the required temperature range of the package, for example.

The status of the recipient is information concerning whether the recipient is at home or away from home at the time of delivery. The information indicates the status of the recipient in the time zone in which the package will arrive at the destination and can be specified by the recipient. The status of the recipient may be data used to estimate whether the recipient is at home or away from home or estimate the time zone in which the recipient is at home.

Whether the door-to-door delivery is needed or not means whether the package needs to be conveyed to the door or not.

In Step S12, the operation command part 1032 selects a vehicle 300 to provide a service. For example, the operation command part 1032 refers to the stored positional information and operational state of the vehicles 300 to select a vehicle 300 that can provide a service.

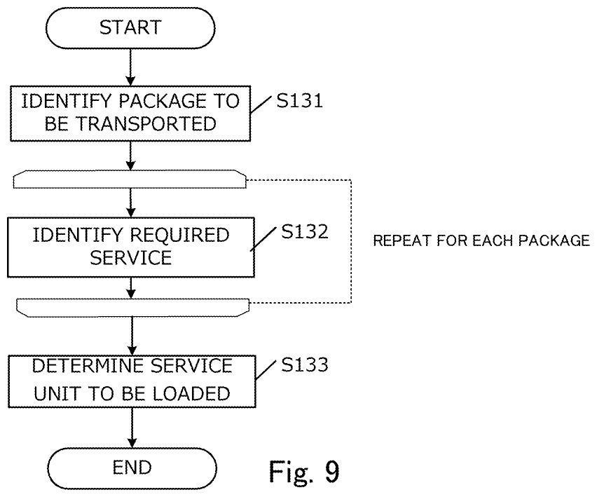

In Step S13, the service unit management part 1033 then determines a service unit 200 to be loaded on the vehicle 300. FIG. 9 is a flowchart illustrating processings performed in Step S13 in detail.

First, in Step S131, the service unit management part 1033 identifies a plurality of packages to be transported by the vehicle 300.

In Step S132, the service unit management part 1033 then identifies a service required when delivering the determined packages. The service required for each package can be determined based on the delivery data and the service data. The processing in Step S132 is repeated for each package.

In Step S133, the service unit management part 1033 determines a service unit to be loaded on the vehicle 300. In this step, the number and types of the service units 200 required to provide the service identified in Step S132 are determined. For example, if there are five packages that require a parcel locker, and four of the five packages require a conveyor apparatus, the service unit management part 1033 determines to load five parcel lockers and one conveyor apparatus on the vehicle.

The description of the process illustrated in FIG. 7 will be resumed.

In Step S14, the service unit management part 1033 generates and outputs a command (referred to as an assembly command) to load the service unit(s) 200 on the vehicle 300. The assembly command includes the identifier of the determined vehicle 300, the identifier(s) of the service unit(s) 200 to be loaded on the vehicle 300, and the identifier(s) of the package(s) to be contained in the service unit(s) 200 (if the service unit(s) 200 is a parcel locker(s)).

Based on the generated assembly command, the service unit(s) 200 is loaded on the vehicle 300. The method of loading the service unit(s) 200 on the vehicle 300 may be a method using a dedicated elevator or a method using an accessory mechanism of the vehicle 300 or the service unit(s) 200, for example. The method is not limited to any particular method as far as the service unit(s) 200 can be lifted and lowered based on the assembly command. If the service unit(s) 200 is loaded by man power, the assembly command may be a command to a worker.

If the service unit(s) 200 is a parcel locker, the package to be transported may be contained in the parcel locker at this stage.

Step S15 is performed if a parcel locker 200 is loaded on the vehicle 300. In this step, the service unit management part 1033 generates a pair of pieces of authentication information required to unlock the compartment in which the package is contained, and transmits first authentication information to the parcel locker 200. The first authentication information may be transmitted by wireless communication or input on the input/output part 204. The service unit management part 1033 also transmits second authentication information to a terminal of the recipient. By checking the first authentication information and the second authentication information against each other, the recipient can receive the package.

In Step S16, the operation command part 1032 generates an operation command that prescribes a travel task performed by the vehicle 300 and a task to be performed by the service unit(s) 200 at the destination, and transmits the operation command to the vehicle 300.

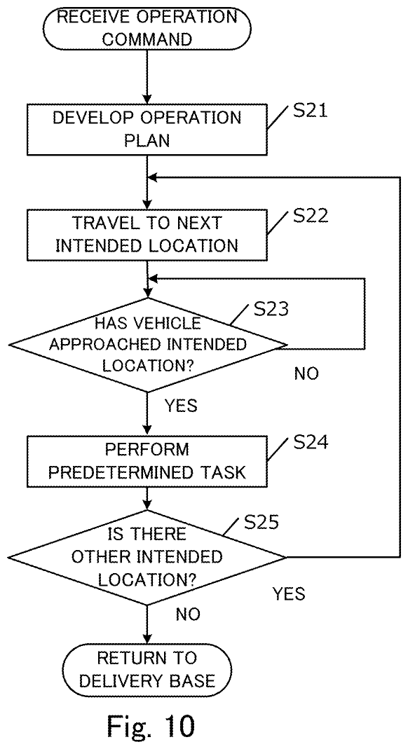

FIG. 10 is a flowchart illustrating a process performed by the vehicle 300 in response to receiving the operation command.

In Step S21, the vehicle 300 (operation plan development part 3031) develops an operation plan based on the received operation command. For example, the operation plan development part 3031 develops an operation plan including a task of identifying a travel route (and the destination of the package) and moving to the destination, a task performed by the service unit(s) 200 at the destination, and a task of returning to a predetermined location (such as a delivery base).

In Step S22, the task control part 3033 makes the vehicle start traveling to an intended location based on the developed operation plan. The intended location is the destination of the package. Note that, during operation, the vehicle information is periodically transmitted to the server apparatus 100.

As the vehicle approaches the destination (Step S23), the task control part 3033 searches for a place where the vehicle can be parked nearby the destination, parks the vehicle at the place, and performs a predetermined task (Step S24). The predetermined task is conveyance of the package by the conveyor apparatus, placement of the parcel locker, or calling of the recipient, for example. Any task involved with the delivery can be performed. The unloading of the package from the vehicle may be performed by the conveyor apparatus or the recipient.

The task control part 3033 then determines whether or not there is another intended location based on the operation plan (Step S25), and continues the operation if there is another intended location. If there is no other intended location, the vehicle returns to the delivery base.

When the recipient comes to the parcel locker 200 placed at a predetermined location, the control part 202 of the service unit 200 acquires the second authentication information via the input/output part 204 and checks the second authentication information against the first authentication information stored in the memory part 203. The second authentication information may be acquired as character data via a keyboard or a touch panel, or acquired as image data via a camera or a scanner. Alternatively, the second authentication information may be acquired via wireless communication.

If it is confirmed that the two pieces of information match with each other, the control part 202 unlocks the relevant compartment. Then, the recipient can pick up the package. When the package is picked up, the control part 202 notifies, via the communication part 201, the service unit management part 1033 of the server apparatus 100 that the package has been picked up. Then, the service unit management part 1033 can grasp the status of package pickup of each service unit 200. If the status of package pickup of the parcel locker 200 satisfies a predetermined condition, the server apparatus 100 can generate an operation command to remove the parcel locker 200 and transmit the operation command to an arbitrary vehicle 300.

If there is a package that has not been picked up from the parcel locker after a lapse of a predetermined time, the service unit management part 1033 may be configured to transmit a reminder to the terminal of the recipient.

As described above, according to the first embodiment, in the system that delivers a package on the vehicle 300, a unit that provides a service can be added to the package. The service unit is appropriately selected based on the attribute of the package to be delivered, the destination of the package, the status of the recipient or the like, so that a service suitable for the circumstance can be provided, and the convenience of the recipient can be improved.

### Second Embodiment

In the first embodiment, the server apparatus 100 determines whether to use the conveyor apparatus 200 (FIG. 2A) based on whether the door-to-door delivery is needed or not. However, depending on the destination building or the geographic features of the destination, for example, a certain type of conveyor apparatus may not be able to be used. For example, if there is a flight of stairs between the road and the entrance, a wheel-type conveyor apparatus cannot be used. To cope with such a situation, the server apparatus 100 can narrow down the types of conveyor apparatuses 200 based on the information about the destination (such as the presence or absence of a flight of stairs, a slope or an elevator).

In the first embodiment, whether to use a parcel locker or not is determined based on whether the recipient is at home or away from home. However, depending on the building, only a limited type of parcel locker can be accepted. For example, concerning the parcel lockers 200 having a capability of connecting to a fixture installed at the building, a parcel locker suitable for the fixture at the building has to be selected.

Furthermore, a parcel locker that can be connected to the ceiling of an elevator car, which can move in the elevator shaft so that the package can be picked up at an arbitrary floor, can be provided. In such a case, the server apparatus 100 needs to select a parcel locker suitable for the manufacturer of the elevator. To this end, the server apparatus 100 can narrow down the types of parcel lockers 200 suitable for the building based on the information about the destination.

(Modifications)

The embodiments described above are just examples, and various modifications are possible without departing from the spirit of the present disclosure.

For example, the processings and units described in the present disclosure can be used in any combination as far as no technical contradiction occurs.

Although the number and types of the service units 200 to be loaded on the vehicle 300 are determined in the embodiments described above, if space permits, any unit that is irrelevant to the delivery of the package (such as a cabin unit) can be loaded to make good use of space.

Although the server apparatus 100 generates the operation command in the embodiments described above, there may be separately provided an apparatus that generates the operation command and an apparatus that generates the assembly command.

Although the vehicle 300 has been illustrated in the embodiments described above, the delivery system according to the embodiments can also be applied to any conveyance other than the vehicle. For example, by loading a service unit on an aircraft platform (such as a drone) or a ship platform, an aircraft or ship used for transportation can be assembled.

Furthermore, a processing described as being performed by one device may be performed in cooperation of a plurality of devices. Alternatively, processings described as being performed by different devices may be performed by one device. In the computer system, the hardware component (server component) that provides each function can be flexibly changed.

The present disclosure can also be implemented by installing a computer program that implements the functions described above with regard to the embodiments in a computer and by one or more processors of the computer reading and executing the program. Such a computer program may be provided to the computer via a non-temporary computer readable memory medium that can be connected to a system bus of the computer, or may be provided to the computer via a network. The non-temporary computer readable memory medium may be any type of disk such as a magnetic disk (such as a floppy (registered trademark) disk or a hard disk drive (HDD)) or an optical disk (such as a CD-ROM, a DVD disk or a Blu-ray disk), or any type of medium suitable for storage of an electronic instruction, such as a read only memory (ROM), a random access memory (RAM), an EPROM, an EEPROM, a magnetic card, a flash memory or an optical card.

What is claimed is:

1. An information processing apparatus comprising a controller configured to
acquire delivery information including information concerning one or more packages transported by a vehicle or a recipient of the one or more packages, and
select, based on the delivery information, one or more service units to be loaded on the vehicle from among a plurality of service units having different capabilities that is accompanied to the one or more packages and provides a service.

2. The information processing apparatus according to claim 1, wherein
the controller further generates a command to load the selected one or more service units on the vehicle.

3. The information processing apparatus according to claim 1, wherein
the plurality of service units includes a first apparatus that conveys a package from the vehicle to the recipient.

4. The information processing apparatus according to claim 3, wherein
the delivery information includes information concerning a location of the recipient, and
the controller selects at least the first apparatus that is suitable for the location of the recipient based on the delivery information.

5. The information processing apparatus according to claim 1, wherein
the plurality of service units includes a second apparatus that functions as a parcel locker capable of being locked with a package contained therein.

6. The information processing apparatus according to claim 5, wherein
the delivery information includes information concerning a location of the recipient, and
the controller selects at least the second apparatus that is suitable for the location of the recipient based on the delivery information.

7. The information processing apparatus according to claim 5, wherein
the delivery information includes information that allows estimation of a time zone in which the recipient is at home, and
the controller estimates whether the recipient is at home at a time of delivery based on the delivery information and selects at least the second apparatus when it is estimated that the recipient is away from home.

8. The information processing apparatus according to claim 7, wherein
the second apparatus is any of a room-temperature storage unit and a refrigerator storage unit having a refrigeration capability.

9. The information processing apparatus according to claim 8, wherein
when it is estimated that the recipient is away from home, the controller selects at least a unit suitable for a package from the room-temperature storage unit and the refrigerator storage unit based on the delivery information.

10. The information processing apparatus according to claim 9, wherein
the controller further determines whether a power supply unit that supplies electricity to the refrigerator storage unit is required or not based on the delivery information.

11. The information processing apparatus according to claim 1, wherein
the controller selects a service unit for each package transported by the vehicle.

12. An information processing method comprising:
a step of acquiring delivery information including information concerning one or more packages transported by a vehicle or a recipient of the one or more packages; and
a step of selecting, based on the delivery information, one or more service units to be loaded on the vehicle from among a plurality of service units having different capabilities that is accompanied to the one or more packages and provides a service.

13. The information processing method according to claim 12, further comprising:
a step of generating a command to load the selected one or more service units on the vehicle.

14. The information processing method according to claim 12, wherein
the plurality of service units includes a first apparatus that conveys a package from the vehicle to the recipient.

15. The information processing method according to claim 13, wherein
the plurality of service units includes a second apparatus that functions as a parcel locker capable of being locked with a package contained therein.

16. The information processing method according to claim 15, wherein
the delivery information includes information that allows estimation of a time zone in which the recipient is at home, and
whether the recipient is at home at a time of delivery is estimated based on the delivery information, and the second apparatus is at least selected when it is estimated that the recipient is away from home.

17. The information processing method according to claim 16, wherein
the second apparatus is any of a room-temperature storage unit and a refrigerator storage unit having a refrigeration capability.

18. The information processing method according to claim 17, wherein
when it is estimated that the recipient is away from home, a unit suitable for a package is at least selected from the room-temperature storage unit and the refrigerator storage unit based on the delivery information.

19. The information processing method according to claim 12, wherein
a service unit is selected for each package transported by the vehicle.

20. A non-transitory computer readable storing medium recording a computer program for causing a computer to perform an information processing method according to claim 12.
